(19) United States
(12) Patent Application Publication
(10) Pub. No.: US 2026/0024085 A1
(43) Pub. Date: Jan. 22, 2026

(54) POINT OF TRANSACTION SYSTEM FOR ONE OR MORE REGULATED SUBSTANCES

(71) Applicants: Anthony Dobek, Minneapolis, MN (US); Lindsay Graves, Minneapolis, MN (US)

(72) Inventors: Anthony Dobek, Minneapolis, MN (US); Lindsay Graves, Minneapolis, MN (US)

(21) Appl. No.: 19/267,528

(22) Filed: Jul. 12, 2025

Related U.S. Application Data
(60) Provisional application No. 63/672,663, filed on Jul. 17, 2024.
(60) Provisional application No. 63/686,712, filed on Aug. 23, 2024.

(51) Int. Cl. G06Q 20/40; G06Q 20/20; G06Q 30/0601

(52) U.S. Cl. CPC G06Q 20/4014; G06Q 20/20; G06Q 30/0607

(57) ABSTRACT

A point of transaction system, such as a point of sale system, for use by a provider of a regulated substance includes a transaction device hiving an input mechanism and an output mechanism, the input mechanism being adapted to receive product information about a regulated substance product and acquirer information about an individual attempting to acquire the regulated substance product. A processor within or in communication with the transaction device is adapted to determine an acquisition history of the individual and assess whether the individual satisfies predetermined regulations at the time of an attempted acquisition based on the product information and the acquisition history of the individual. An output signal provides either a transaction authorization or a transaction denial. A method of using the point of transaction system at an event is also provided.

### PRIORITY

The present application claims the benefit of domestic priority based on U.S. Provisional Patent Application 63/686,712 filed on Aug. 23, 2024, and on U.S. Provisional Patent Application 63/672,663 filed on Jul. 17, 2024, the entireties of both of which are incorporated herein by reference.

### BACKGROUND

The sale of regulated substances, such as controlled substances and alcohol, is replete with risks. For example, there are risks of violating governmental regulations, breaking insurance requirements, and/or being liable for acts that result from the sale. The problem is further complicated by the fact that laws, regulations, and mandates constantly change and/or vary from state to state. In addition to these risks, establishments and managers have a moral obligation to make sure a regulated substance is not being abused, oversold, and/or sold to the wrong individuals.

Of particular interest and concern is the sale of intoxicating regulated substances for recreational use, such as alcohol and cannabis-related products. Both the alcohol industry and the cannabis industry account for several billions of dollars of sales. Regulations regarding alcohol use and sales are relatively established even though the regulations vary across states and sales platforms. Legalized cannabis sales, on the other hand, are relatively new. Accordingly, cannabis regulations vary widely and are constantly evolving as new products enter the market. For example, products such as infused beverages and edible products that contain substances found in the cannabis plant called cannabinoids are becoming increasingly popular. Two such cannabinoids are tetrahydrocannabinol (THC) and cannabidiol (CBD). While THC has more of an intoxicating effect than CBD, both are subject to various regulations and ingestion considerations.

Point of sale systems for alcohol and cannabis products have been created to help establishments keep track of sales transactions. Existing point of sale systems keep a record of sales for tax and bookkeeping purposes. Some point of sales systems also help an establishment monitor and/or maintain inventory of particular items. However, current point of sales systems do not allow for tracking or monitoring of an individual's purchases over time, making it difficult and sometimes impossible to know how much of a regulated substance an individual has purchased and/or consumed. This puts a burden on sales staff to subjectively monitor the state of intoxication of individuals and to make a judgment call on whether the individual is in condition to make a purchase. When such a determination is made, the sales staff can be harassed by angry and/or belligerent customers. Additionally, it is often in an establishment's best interest to make a sale and thus the establishment may be tempted to turn a blind eye to a situation rather than lose potential income. The challenge of making sure an individual is in proper condition to purchase a regulated substance is even greater at large events where multiple purchasing sites are available and where multiple the number of customers is too large for sales staff to adequately monitor everyone's activities.

There is therefore a need for a way to make objective decisions about whether or not a regulated substance should or should not be sold or provided to an individual at a particular time. There is further a need for a point of transaction system, such as a point of sale system, that tracks an individual's purchases of a regulated substance over time. There is a further need for an event-based point of transaction system, such as a point of sale system, that tracks an individual's regulated substance purchasing activity across multiple transaction or sales sites at the event.

### SUMMARY

The present invention satisfies these needs. In one aspect of the invention, a system and method is provided that makes objective decisions at the point of transaction, such as a point of sale, of a regulated substance.

In another aspect of the invention, a system and method is provided that makes objective decisions based on an individual's acquisition history of a regulated substance.

In another aspect of the invention, a system and method is provided that makes objective decisions based on an individual's acquisition history of a regulated substance at an event.

In another aspect of the invention, a system and method is provided that makes objective decisions based on an individual's acquisition history of a regulated substance over a preceding period of time.

In another aspect of the invention, a point of transaction system, such as a point of sale system, is provided that tracks an individual's purchases or other acquisitions of a regulated substance at an event.

In another aspect of the invention, a point of transaction system, such as a point of sale system, is provided that tracks an individual's purchases or other acquisitions of a regulated substance at an event over a time period.

In another aspect of the invention, a point of transaction system, such as a point of sale system, is provided that tracks an individual's purchases or other acquisitions of a regulated substance at an event over a time period preceding an attempted purchase or other acquisition of a regulated substance.

In another aspect of the invention, a point of transaction system, such as a point of sale system, is provided that tracks an individual's purchases or other acquisitions of a regulated substance at an event and makes an assessment of whether a purchase or other acquisition of a regulated substance by the individual should be authorized or denied.

In another aspect of the invention, a point of transaction system, such as a point of sale system, is provided that tracks an individual's purchases or other acquisitions of a regulated substance at an event over a time period and makes an assessment of whether a purchase or other acquisition of a regulated substance by the individual should be authorized or denied.

In another aspect of the invention, a point of transaction system, such as a point of sale system, is provided that associates an individual with a purchase or other acquisition and makes future purchase decisions based on the association.

In another aspect of the invention, a point of transaction system, such as a point of sale system, is provided that associates an individual with a purchase or other acquisition and with a time of the purchase or other acquisition and makes future purchase decisions based on the association.

In another aspect of the invention, a point of transaction system, such as a point of sale system, makes a determination of how much of a regulated substance an individual has purchased or otherwise acquired at an event and makes an assessment as to whether or not the individual may or may not make a purchase.

In another aspect of the invention, a point of transaction system, such as a point of sale system, makes a determination of how much of a regulated substance an individual has purchased or otherwise acquired at an event over a time period and makes an assessment as to whether or not the individual may or may not make a purchase.

In another aspect of the invention, a point of transaction system, such as a point of sale system, operates as a compliance system, a compliance verification system, and/or a consumption compliance verification system that assures an event or establishment is operating in compliance with one or more regulations.

In another aspect of the invention, a method of using a point of transaction system, such as a point of sale system, comprises using a point of transaction system as described herein in the manner described herein.

In another aspect of the invention, a point of transaction system, such as a point of sale system, for use by a provider of a regulated substance comprises a transaction device comprising an input mechanism and an output mechanism, the input mechanism being adapted to receive (i) product information about a regulated substance product and (ii) acquirer information about an individual attempting to acquire the regulated substance product, the acquirer information comprising information related to the identification of the individual; a processor within or in communication with the transaction device; and a storage module within or in communication with the processor, wherein the processor is adapted to: receive the product information and the acquirer information from the transaction device; determine an acquisition history of the individual; assess whether the individual satisfies predetermined regulations at the time of an attempted acquisition based on the product information and the acquisition history of the individual; generate an output signal in relation to the determination; and provide the output signal to the transaction device, wherein the provider can input the product information and the acquirer information into the transaction device using the input mechanism, and wherein the provider can receive from the transaction device output mechanism a transaction authorization when the individual satisfies the predetermined regulations or a transaction denial when the individual does not satisfy the predetermined regulations.

In another aspect of the invention, a point of transaction system, such as a point of sale system, for use by a provider of a regulated substance comprises a transaction device comprising an input mechanism and an output mechanism, the input mechanism being adapted to receive (i) product information about a regulated substance product and (ii) acquirer information about an individual attempting to acquire the regulated substance product, the acquirer information comprising information related to the identification of the individual; a processor within or in communication with the transaction device; and a storage module within or in communication with the processor, wherein the processor is adapted to: receive the product information and the acquirer information from the transaction device; determine an acquisition history of the individual; assess whether the individual satisfies predetermined regulations at the time of an attempted acquisition based on the product information and the acquisition history of the individual; generate an output signal in relation to the determination; and provide the output signal to the transaction device, wherein the provider can input the product information and the acquirer information into the transaction device using the input mechanism, and wherein the provider can receive from the transaction device output mechanism a transaction authorization when the individual satisfies the predetermined regulations or a transaction denial when the individual does not satisfy the predetermined regulations, wherein the processor determines the acquisition history of the individual by determining a number of regulated substance products the individual has acquired within a preceding time period, wherein the processor assesses whether the individual satisfies the predetermined regulations by comparing the number of regulated substances the individual has acquired within the preceding time period to a preset limit, and wherein the processor generates the output signal by generating a transaction authorization output signal when the number of regulated substance products the individual has acquired within the preceding time period is below the preset limit and generating a transaction denial output signal when the number of regulated substance products the individual has acquired within the preceding time period is not below the preset limit.

In another aspect of the invention, a point of transaction system, such as a point of sale system, for use by a provider of a regulated substance comprises a transaction device comprising an input mechanism and an output mechanism, the input mechanism being adapted to receive (i) product information about a regulated substance product and (ii) acquirer information about an individual attempting to acquire the regulated substance product, the acquirer information comprising information related to the identification of the individual; a processor within or in communication with the transaction device; and a storage module within or in communication with the processor, wherein the processor is adapted to: receive the product information and the acquirer information from the transaction device; determine an acquisition history of the individual; assess whether the individual satisfies predetermined regulations at the time of an attempted acquisition based on the product information and the acquisition history of the individual; generate an output signal in relation to the determination; and provide the output signal to the transaction device, wherein the provider can input the product information and the acquirer information into the transaction device using the input mechanism, and wherein the provider can receive from the transaction device output mechanism a transaction authorization when the individual satisfies the predetermined regulations or a transaction denial when the individual does not satisfy the predetermined regulations, wherein the product information comprises the amount of regulated substance within the regulated substance product, wherein the processor determines the acquisition history of the individual by determining the amount of regulated substance the individual has acquired within a preceding time period, wherein the processor assesses whether the individual satisfies the predetermined regulations by comparing the amount of regulated substance the individual has acquired within the preceding time period to a preset limit, and wherein the processor generates the output signal by generating a transaction authorization output signal when the amount of regulated substance the individual has acquired within the preceding time period is below the preset limit and generating a transaction denial output signal when the amount of regulated substance the individual has acquired within the preceding time period is not below the preset limit.

In another aspect of the invention, a method of determining whether a regulated substance product can be provided to an individual attempting to acquire the regulated substance product comprises providing a transaction device comprising an input mechanism and an output mechanism; using the input mechanism to enter product information about the regulated substance product; using the input mechanism to enter acquirer information about individual, the acquirer information comprising information related to the identification of the individual; determining an acquisition history of the individual; assessing whether the individual satisfies predetermined regulations at the time of an attempted acquisition based on the product information and the acquisition history of the individual; and using the output mechanism to indicate the individual is authorized to acquire the regulated substance product when the individual satisfies the predetermined regulations or to indicate the individual is denied from acquiring the regulated substance product when the individual does not satisfy the predetermined regulations.

In another aspect of the invention, a method of determining whether a regulated substance product can be provided to an individual attempting to acquire the regulated substance product comprises providing a transaction device comprising an input mechanism and an output mechanism; using the input mechanism to enter product information about the regulated substance product; using the input mechanism to enter acquirer information about individual, the acquirer information comprising information related to the identification of the individual; determining an acquisition history of the individual; assessing whether the individual satisfies predetermined regulations at the time of an attempted acquisition based on the product information and the acquisition history of the individual; and using the output mechanism to indicate the individual is authorized to acquire the regulated substance product when the individual satisfies the predetermined regulations or to indicate the individual is denied from acquiring the regulated substance product when the individual does not satisfy the predetermined regulations, wherein the step of determining an acquisition history of the individual comprises determining a number of regulated substance products the individual has acquired within a preceding time period, and wherein the step of assessing whether the individual satisfies the predetermined regulations comprises comparing the number of regulated substances the individual has acquired within the preceding time period to a preset limit.

In another aspect of the invention, a method of determining whether a regulated substance product can be provided to an individual attempting to acquire the regulated substance product comprises providing a transaction device comprising an input mechanism and an output mechanism; using the input mechanism to enter product information about the regulated substance product; using the input mechanism to enter acquirer information about individual, the acquirer information comprising information related to the identification of the individual; determining an acquisition history of the individual; assessing whether the individual satisfies predetermined regulations at the time of an attempted acquisition based on the product information and the acquisition history of the individual; and using the output mechanism to indicate the individual is authorized to acquire the regulated substance product when the individual satisfies the predetermined regulations or to indicate the individual is denied from acquiring the regulated substance product when the individual does not satisfy the predetermined regulations, wherein the product information comprises the amount of regulated substance within the regulated substance product, wherein the step of determining the acquisition history of the individual comprises determining the amount of regulated substance the individual has acquired within a preceding time period, and wherein the step of assessing whether the individual satisfies the predetermined regulations comprises comparing the amount of regulated substance the individual has acquired within the preceding time period to a preset limit.

In another aspect of the invention, a method of hosting an event in which a regulated substance is provided comprises prior to providing a regulated substance to an individual in attendance at the event, determining the number of regulated substance products or the amount of the regulated substance the individual has been provided within a preceding time period, if the number of regulated substance products the individual has been provided within the preceding time period is below a preset limit or if the amount of the regulated substance the individual has been provided within the preceding time period is below a preset limit, providing the individual with the regulated substance, and if the number of regulated substance products the individual has been provided within the preceding time period is not below a preset limit or if the amount of the regulated substance the individual has been provided within the preceding time period is not below a preset limit, denying the individual the regulated substance.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic diagram of a point of transaction system of the invention in use;

FIG. 2 is a schematic flow chart of a version of a transaction authorization process performable by the point of transaction system of FIG. 1;

FIG. 3 is a schematic flow chart of another version of a transaction authorization process performable by the point of transaction system of FIG. 1;

FIG. 4 is a schematic flow chart of another version of a transaction authorization process performable by the point of transaction system of FIG. 1;

FIG. 5 is a schematic flow chart of another version of a transaction authorization process performable by the point of transaction system of FIG. 1;

FIG. 6 is a schematic flow chart of another version of a transaction authorization process performable by the point of transaction system of FIG. 1;

FIG. 7 is a schematic flow chart of another version of a transaction authorization process performable by the point of transaction system of FIG. 1;

FIG. 8 is a schematic flow chart of another version of a transaction authorization process performable by the point of transaction system of FIG. 1;

FIG. 9 is a schematic flow chart of another version of a transaction authorization process performable by the point of transaction system of FIG. 1;

FIG. 10 is a schematic flow chart of another version of a transaction authorization process performable by the point of transaction system of FIG. 1;

FIG. 11 is a schematic flow chart of another version of a transaction authorization process performable by the point of transaction system of FIG. 1;

FIG. 12 is a schematic flow chart of another version of a transaction authorization process performable by the point of transaction system of FIG. 1;

FIG. 13 is a schematic diagram of another version of the point of transaction system of the invention;

FIG. 14A is a schematic representation of a sample of a transaction authorization display screen for a version of the point of transaction system of the invention;

FIG. 14B is a schematic representation of a sample of a transaction authorization screen for a version of the point of transaction system of the invention;

FIG. 14C is a schematic representation of a sample of a transaction denial screen for a version of the point of transaction system of the invention; and

FIG. 15 is a schematic representation of a sample regulations entry screen for a version of the point of transaction system of the invention.

### DESCRIPTION

The present invention relates to a point of transaction system, such as a point of sale system. In particular, the invention relates to a point of transaction system that monitors and/or tracks an individual's purchase or acquisition activity for the purpose of assessing whether a purchase or acquisition can be made. Although the point of transaction system is illustrated and described in the context of being useful for tracking the purchasing or acquiring of one or more regulated substances, the present invention can be useful in other instances. Accordingly, the present invention is not intended to be limited to the examples and embodiments described herein.

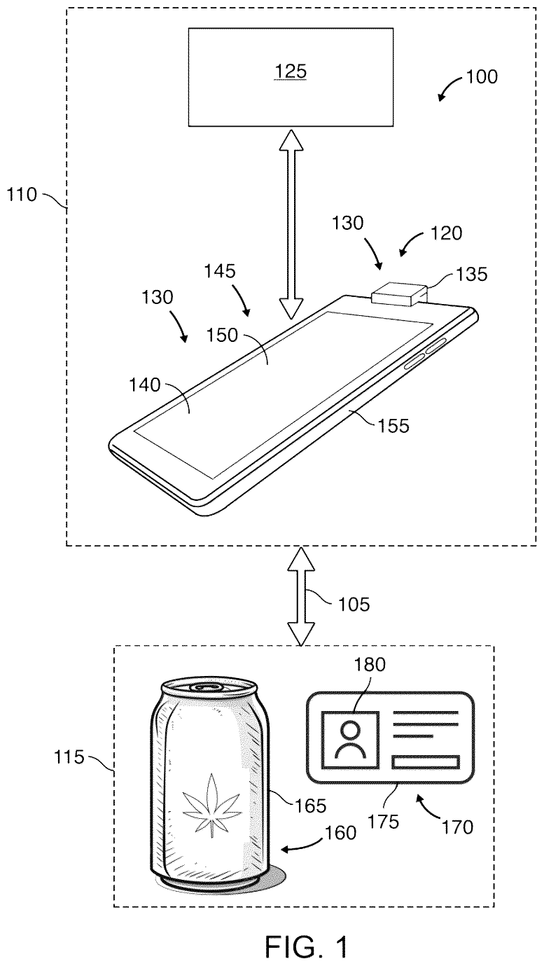

FIG. 1 shows a point of transaction system 100 of the invention. The point of transaction system 100 is useful in recording, tracking, and/or monitoring an individual's purchases or acquisitions of one or more regulated substances over time. By point of transaction system it is meant any system that is used during or in proximity to a transaction where an individual attempts to purchase or otherwise acquire a regulated substance. For example, a point of transaction system can be or can be included within or alongside a point of sale (or POS) system. By regulated substance it is meant any substance for which a regulation exists concerning the purchase, acquisition, and/or use of the regulated substance. The regulation can involve, for example, requirements on the status of the individual, such as the individual's age, requirements on the amount of the regulated substance that can be purchased, and/or requirements on the condition of the individual, such as the individual's sobriety. The regulation can be a governmentally imposed regulation, an insurance requirement, a self-imposed requirement by an establishment or event, or any other limit on the purchasing or acquiring of a substance. Examples of regulated substances include alcohol products, cannabis products, mushroom psilocybin products, and other intoxicants. Alcohol products include any beverage that contains a measurable amount of ethanol, such as beer, wine, spirits, and the like. Cannabis refers to all products derived from the plant Cannabis sativa. Cannabis products include any product that includes cannabis in any form including cannabis, marijuana, a chemical substance from cannabis including cannabinoids, such as tetrahydrocannabinol (THC) and/or cannabidiol (CBD), or specific forms of cannabinoids, such as Delta 9 or Delta 8. The cannabis product can contain natural or synthetic cannabis. Forms of cannabis include cannabis flower, also known as weed, that can include one or more of dried flowers, buds, stems, seeds, and leaves that are typically rolled and smoked or inhaled through a vaporizer, pipe, or water pipe. Cannabis can also be present in the form of extracts or concentrates, hashish, oil, butane hash oil, and tinctures, each of which can be smoked, vaporized, dabbed, and/or ingested. Increasingly common forms of cannabis products are edibles, where cannabis in any form is mixed with an edible product such as a brownie, gummy or hard candy, cookies, or the like, and cannabis-infused beverages, where THC, CBD, or other cannabinoid is infused into a tea or a canned or bottled beverage. The point of transaction system 100 can thus function as a compliance system, a compliance verification system, and/or a consumption compliance verification system whereby it assures an event or establishment is operating in compliance with one or more regulations, such as governmentally impose and/or insurance regulations.

Of particular applicability for the point of transaction system 100 of FIG. 1 is for use at an event held within a contained or known event space where the regulated substance is consumed on site within the event space. The event can be a small event such as the regular operation of a restaurant, bar, tasting room, or the like, or a large event, such as a sporting event, concert, fair, block party, bar crawl, or the like. Within and during such events, one or more regulated substances may be sold and consumed, and an establishment, owner, worker, event coordinator, or management group can use the point of transaction system 100 of the invention to monitor and control the purchasing or acquiring of the regulated substance during the event and thereby be able to reduce the risk of an individual over-consuming or over-purchasing a regulated substance. By taking steps to reduce the risk of selling or providing a regulated substance to an individual who does not meet regulated guidelines for purchasing or acquiring the regulated substance within the event space, the seller can enforce the regulations and can help protect themselves from liability.

As shown in FIG. 1, the point of transaction system 100 allows for controlled interaction 105 between a provider 110 of a regulated substance and an individual 115, or acquirer, who is desirous of purchasing or otherwise acquiring a regulated substance. The provider 110 can be, for example, an operator associated with an event, such as an owner, manager, overseer, and/or an individual working an event, such as a seller or vendor of a regulated substance. The point of transaction system 100 comprises a transaction device 120, such as a sales device, and a processor 125 in communication with the transaction device 120. The transaction device 120 will include one or more input mechanisms 130, such as a card reader 135 and/or a touch screen 140, and one or more output mechanisms 145, such as a display screen 150 or other sensory communicator such as an audible beep or visible light. In the particular version of FIG. 1, the transaction device 120 is shown in the form of a portable electronic device, such as a computer tablet 155, or any other portable electronic device, such as a lap top computer, smart phone, personal digital assistant, virtual reality device, and/or the like. Alternatively, the transaction device 120 can be in any other conventional form, such as a desktop computer, cash register, kiosk, and/or the like. The processor 125 can be housed within the transaction device 120 or can be a separate device or computer server that is accessed remotely and in electronic communication with the transaction device 120, as will be discussed further hereinbelow. The processor 125 contains one or more modules or routines capable of performing calculations and/or programmable actions in response to information or an input signal received from the transaction device 120 and capable of providing information or an output signal to the transaction device 120 in response to the calculations or programmable actions within its modules or routines. The transaction device 120 may be a single device that handles both the input and output functions of the transaction device 120, such as the tablet 155 shown, or can be a collection of multiple units that each have separate functions.

The point of transaction system 100 of the invention is used during the interaction 105 between the provider 110 and the individual 115 when the individual 115 is interested in purchasing or otherwise acquiring one or more regulated substance products 160. In the particular version of FIG. 1, the regulated substance product 160 exemplified is a cannabis-infused beverage 165, though it can be any other regulated substance product or combination of regulated substance products. The individual 115 that is desirous of purchasing or otherwise acquiring the regulated substance product 160 carries an individual identifier 170, such as an identification card 175 as shown in FIG. 1. When the individual identifier 170 is an identification card 175, the identification card 175 can include a photo 180 of the individual or other manner of associating the identification card 175 with the individual 115. In one version, the individual identifier 170 can be a driver's license or other government issued identification. In another version, which can be particularly useful for some types of events, an individual identifier 170 can be provided by the event host for each individual attending the event. In this version, the individual identifier can be an identification card such as the one shown in FIG. 1. Alternatively, the individual identifier 170 can be a wearable item, such as a badge or a bracelet that includes printed or electronic information that associates to the individual 115.

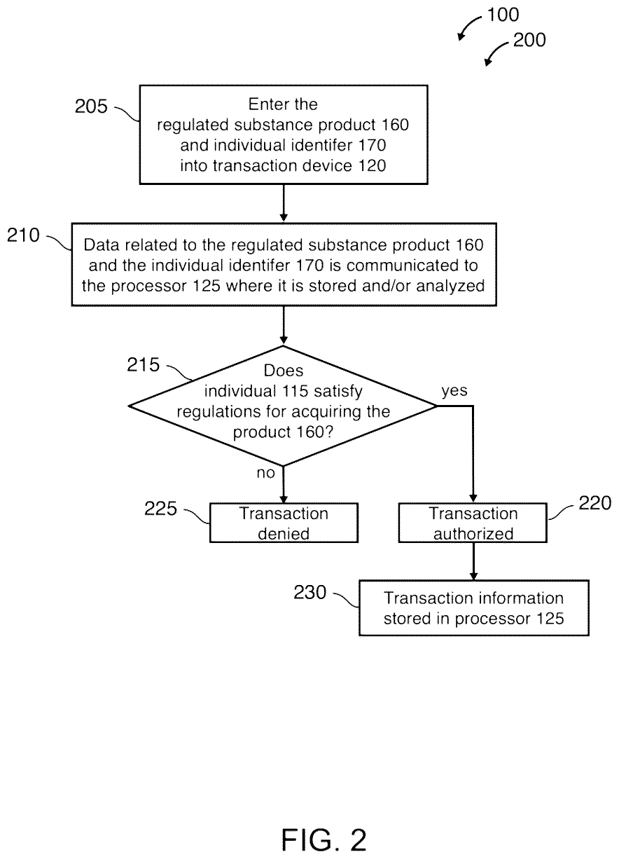

The point of transaction system 100 of the invention performs a transaction authorization process 200, such as a sales authorization process, that determines whether or not a transaction, such as a sale, can occur, as illustrated in FIG. 2. For an individual to be able to purchase or otherwise acquire the regulated substance product 160, the regulated substance product 160 and information from individual identifier 170 is entered 205 into the transaction device 120. Data related to the regulated substance product 160 and the individual 115 is communicated 210 to the processor 125 where it is logged and stored. An assessment 215 is then made as to whether or not the individual 115 satisfies the regulations for purchasing or otherwise acquiring the product 160. If the answer to the assessment 215 is yes, the transaction is authorized 220. If the answer to the assessment is no, the transaction is denied 225. If the transaction is authorized 220, the record of the purchase, including the individual 115 and the product 160 is stored 230 in the processor 125. In many instances, the transaction is a purchase request. In other instances there may be no actual purchase transaction that takes place following transaction authorization. For example, some events may operate in an open-bar type manner, such as in a manner where an event offers free products to individuals and the event organizers or other party pays for the total number of products distributed, where it may be important to monitor or track the number of acquisitions, and some events may operate with tokens or the like where there is no actual transfer of money during the acquisition transaction.

The entry 205 of the information related to the regulated substance product 160 and the individual 115 can be in any conventional manner. For example, for the individual 115, the individual identifier 170 can be scanned by the card reader 135 or other scanning device or information from the individual identifier 170 can be entered into the transaction device 120 using a keyboard or the touchscreen 140. Alternatively, the individual identifier 170 can communicate electronically with the transaction device 120, such as by radio frequency identification. For the regulated substance product 160, the product can be scanned, such as by bar code reader, or the product can be entered by the touchscreen 140 or other data entry technique. The entry 205 of the information can be performed by either the provider 110 or the individual 115.

The step of assessing 215 whether or not the individual 115 is entitled to purchase or otherwise acquire the regulated substance product 160 can be performed by the processor 125 in accordance with pre-preprogrammed regulation requirements. The processor 125 determines if the purchase or acquisition of the product 160 would violate any programmed regulations, and if so, the processor 125 generates a signal that is sent to the transaction device 120 indicating that a transaction is not authorized 225. Conversely, if there are no violated regulations, the processor 125 sends a signal to the transaction device 120 indicating authorization 220 of the purchase or transaction. For example, the results of the assessment 215 can be communicated by a message stating “Transaction Approved” or “Sale Approved” or the like to the display screen 150 and/or by causing an approval-indicating or approval-denying sound or light to be activated. Alternatively, instead of the processor 125 returning an authorized or denied signal or indication, the processor 125 can send relevant information to the display screen 150 that will allow the provider 110 or operator of the transaction device 120 to make an assessment of the satisfying of the regulations. In one version, the indication of approval can be required before a transaction can take place. Alternatively, the indication can be merely informative and the provider 110 can have the option of continuing with the transaction.

The requirements of a regulation that is being assessed in step 215 can be any regulation that has been entered into the processor 125 and can vary from event to event and/or from product to product. Before an event starts, someone associated with an event, such as an event owner or manager, can enter the regulation requirements into the processor 125 or the regulations can be unalterably built into the system as required by law or other regulation. The requirements can relate to government mandated regulations, insurance requirements, or can be event-specific regulations chosen by the event owner or manager.

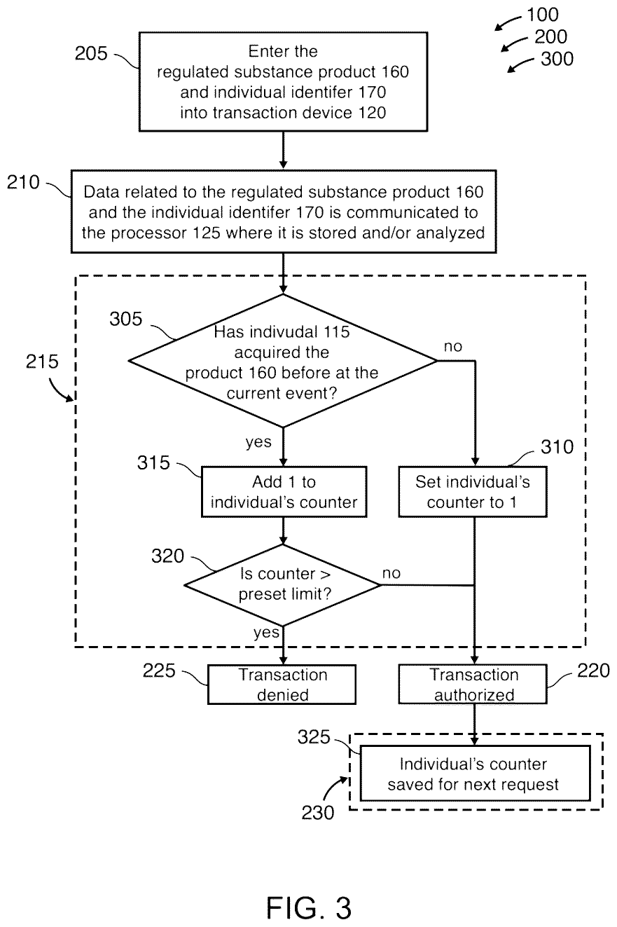

For example, FIG. 3 illustrates a particular transaction authorization process 200 capable of being performed by the point of transaction system 100. The process of the version of FIG. 3 is a product quantity limiting process 300 that takes into account the regulated substance acquisition history of individual 115 and that can be used when an event wants to impose a limit on the number or quantity of regulated substance products that can be purchased or otherwise acquired by an individual 115. For example, the event may be offering a standard size cannabis-infused beverage that has a known amount of THC or other active ingredient, or the event may be offering various products that each contain approximately the same amount of THC or other active ingredient. In this case, the event may wish to and/or may be required to limit the quantity of such products an individual can purchase or otherwise acquire. For this version, as shown in FIG. 3, the assessment step or routine performed by the processor 125 first checks 305 to see if the individual 115 attempting to purchase or otherwise acquire the regulated substance product 160 has acquired a regulated substance product at the current event. The process 125 keeps and stores a record of all purchases or acquisitions of the regulated substance product by each individual in attendance at the event. If the current purchase or acquisition request is the first purchase or acquisition by the individual 115 of the regulated substance product 160, the processor routine continues to step 310 where a counter associated with the individual 115 is set to 1, and the transaction is authorized 220. If the acquisition is not the first such acquisition for the individual 115, the processor proceeds to step 315 where the individual's counter is increased by 1. The value of the counter is then compared 320 to the imposed limit on acquisitions of the product 160 that has been preset and pre-entered into the processor 125. If the individual's counter is greater than the preset limit, the transaction is denied 225. Otherwise, the transaction is approved 220. Once authorized, the individual can continue with the transaction, such as a purchase of the product 160, in conventional manner. Following the purchase or acquisition, the individual's counter is saved 325 so that it can be referred to again when the individual attempts another purchase or acquisition of the product 160. If the individual decides to not proceed with the transaction following authorization, the counter will revert back to its setting prior to the current transaction authorization request.

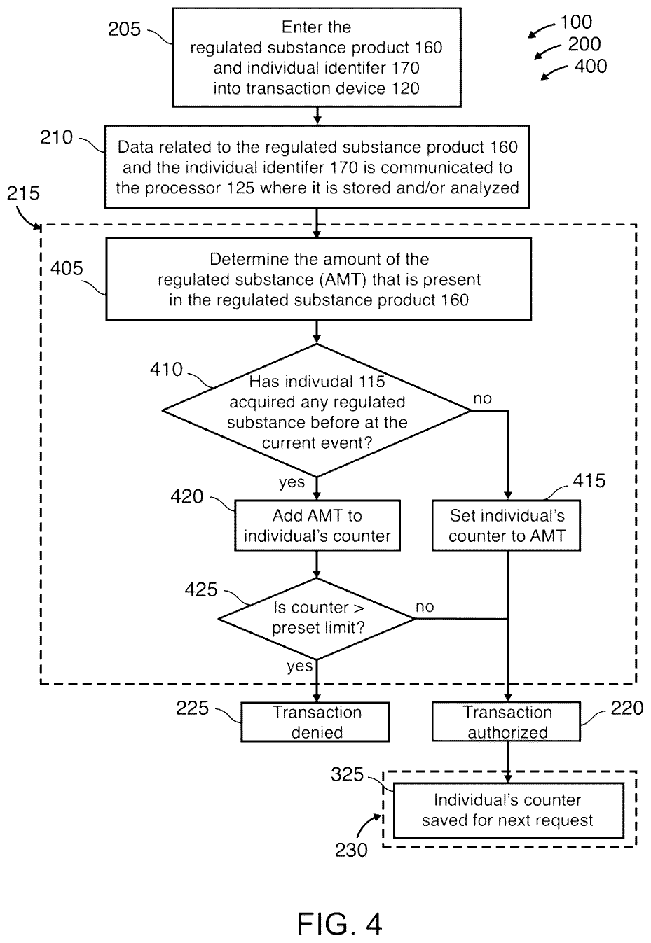

FIG. 4 illustrates another version of a transaction authorization process 200 capable of being performed by the point of transaction system 100. The version of FIG. 4 is a regulated substance amount limiting process 400 that also takes into account the regulated substance acquisition history of individual 115. With the version of FIG. 4, rather than keep track of the number of regulated substance products purchased or acquired by an individual 115 during an event like in the version of FIG. 3, the version of FIG. 4 monitors and/or determines the amount of the regulated substance that has been purchased or acquired by the individual 115. The version of FIG. 4 is useful when multiple products having differing amounts of regulated substance are available for purchase or acquisition at the event. In this version, the assessment 215 starts with a determination 405 of the amount of a regulated substance that is present in a product 160 that is attempted to be purchased or acquired by the individual 115. This determination 405 can be made by the processor 125 by direct entry of the amount (AMT) of the regulated substance, by calculation of the amount (AMT), by a look-up table accessible by the processor 125, or the like. The processor 125 then checks 410 to see if this purchase or acquisition by the individual 115 would be the first purchase or acquisition of the regulated substance at the event. If so, the individual's counter is set 415 at the amount (AMT) of the regulated substance determined from step 405, and the transaction is authorized 220. If this is not the first purchase or acquisition at the event, the individual's counter 420 is increased 420 by the amount (AMT) of the regulated substance determined from step 405. The processor 425 then compares 425 the counter amount total to a preset limit for the amount of the regulated substance that can be purchased or acquired by an individual 115 at the event, and if the counter exceeds the limit, the transaction is denied 425.

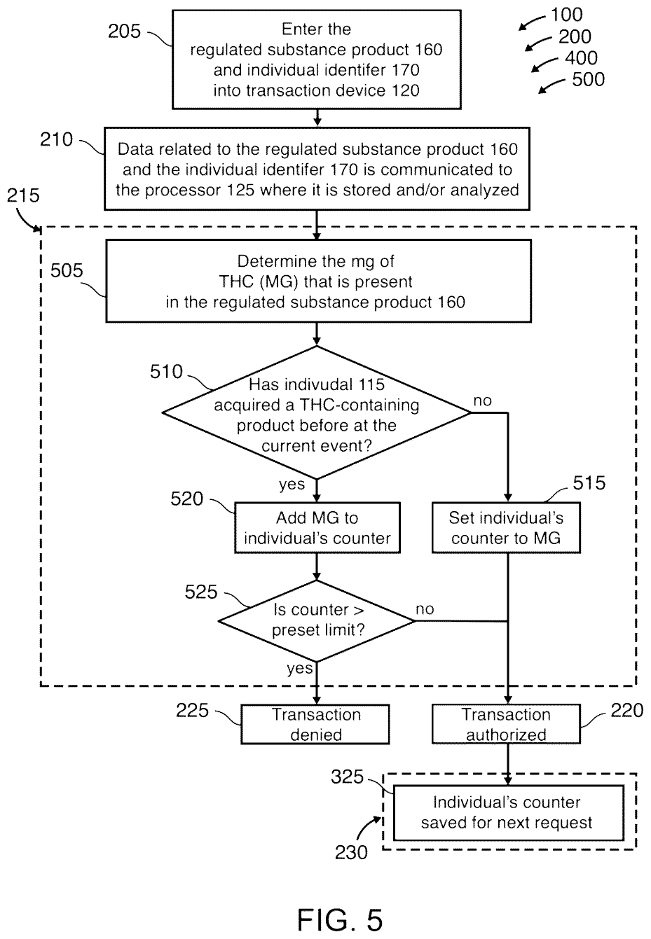

A particular example of a regulated substance amount limiting process 400 is shown in FIG. 5. The version of FIG. 5 is a THC amount limiting process 500. This version is particularly useful at events where THC-containing beverages and/or THC-containing edible products are available for purchase or acquisition. For the determination step 505, the processor 115 determines the milligrams (mg), or other unit, of THC that are present in a product 160 to be purchased. Steps 510, 515, 520, and 525 are similar to steps 410, 415, 420, and 425 of FIG. 4, respectively, but with mg of THC (MG) being the amount (AMT) that is monitored and compared to the set limit.

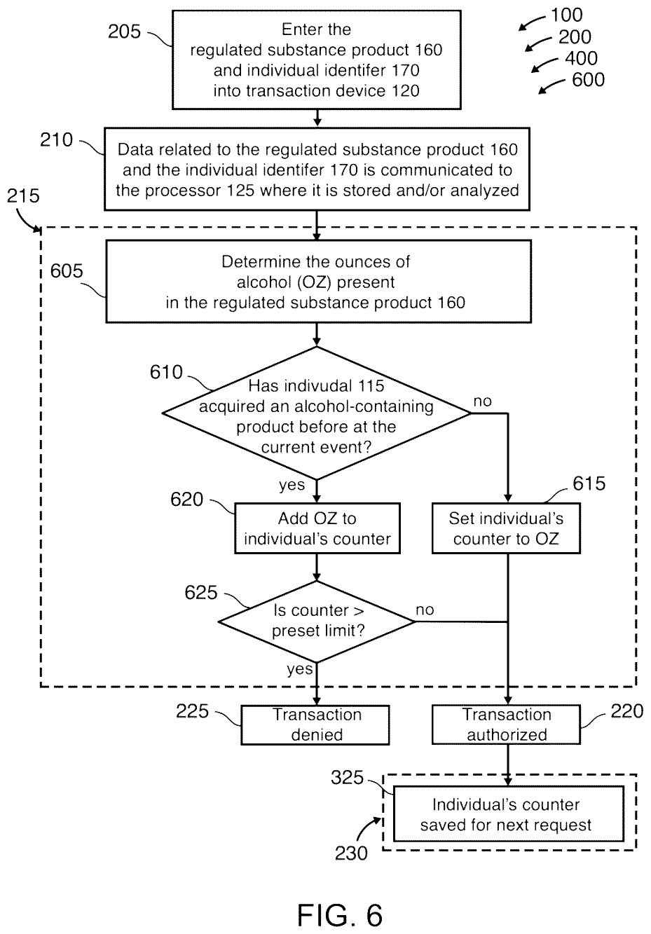

Another particular example of a regulated substance amount limiting process 400 is shown in FIG. 6. The version of FIG. 6 is an alcohol amount limiting process 600. This version is particularly useful at events where multiple alcohol-containing beverages are available for purchase or acquisition at an event. For the determination step 605, the processor 115 determines the ounces of alcohol (OZ) that are present in a product 160 attempting to be acquired. Steps 610, 615, 620, and 625 are similar to steps 410, 415, 420, and 425 of FIG. 4, respectively, but with ounces of alcohol (OZ) being the amount (AMT) that is monitored and compared to the set limit. By ounces, it can be ounces by weight or volume or can be any other measure of the amount of alcohol purchased or acquired by the individual. Often, the amount of alcohol that is present in a product 160 is expressed in terms of its standard measurement of alcohol by volume (ABV) or proof (which in the United States is two times the ABV). Accordingly, in one version, the processor 115 at step 605 can calculate the ounces of alcohol in a product 160 by knowing ABV or proof and the total volume of the product 160 or alcoholic beverage within the product.

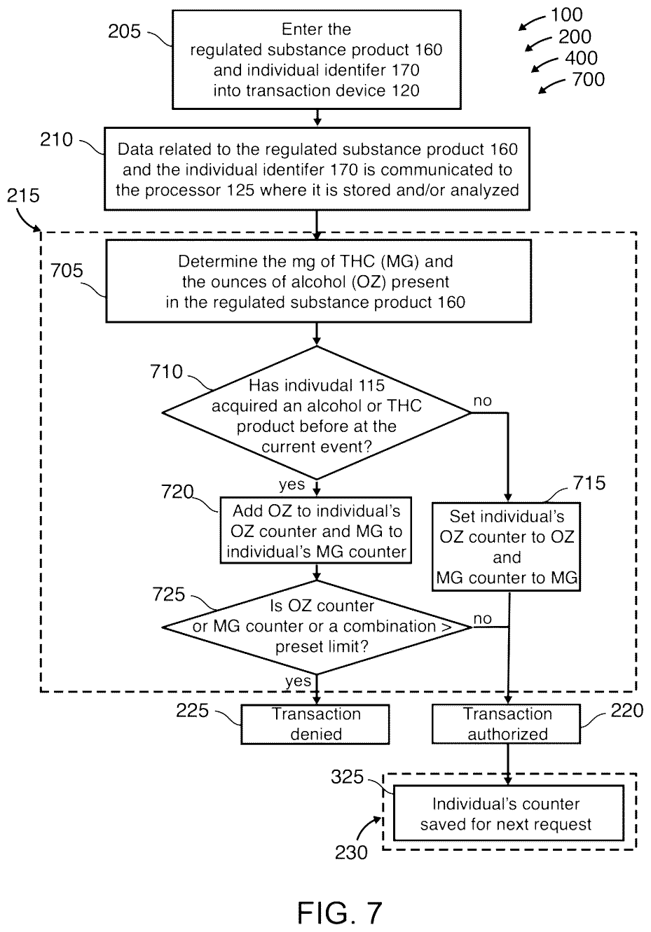

A particular example of a regulated substance amount limiting process 400 is shown in FIG. 7. The version of FIG. 7 is a combination of product amounts limiting process 700. This version is particularly useful at events where a combination of regulated substances are available, such as an event where both THC-containing products 160 and alcohol-containing products 160 are available for purchase or acquisition. For the determination step 705, the processor 115 determines the milligrams (MG), or other unit, of THC and/or the ounces of alcohol (OZ) that are present in the product. Steps 710, 715, 720, and 725 are similar to steps 410, 415, 420, and 425 of FIG. 4, respectively, but with both the mg of THC (MG) and the ounces of alcohol (OZ) being separately monitored and separately compared to their respective limits. If either limit is exceeded, the transaction is denied 225. Optionally, the transaction can also be denied if some regulated combination of the regulated substances is achieved. For example, the event may prohibit any mixing of the regulated substances or may imposed different limits when mixing does occur. For example, the limit of allowable THC and/or alcohol may be cut in half, or any other percentage, when mixed purchases or acquisitions are attempted.

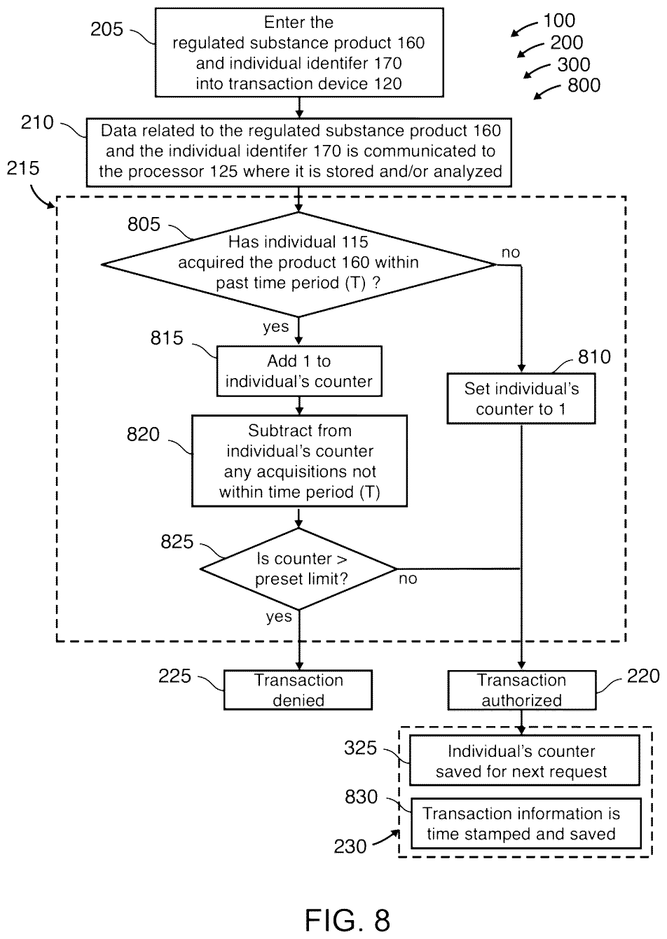

Some events, such as fairs and concert festivals, may transpire over a long period of time. In such cases, it may be desirable to monitor an individual's purchases or acquisitions over time and limit the purchases or acquisitions in a timewise manner. FIGS. 8 through 12 illustrate transaction authorization processes where time or a time period is taken into consideration when making the transaction authorization assessment 215. To perform these processes, the point of transaction system 100 and the processor 125 have time and/or time period determining capabilities. Each sale is time stamped and data for each transaction, including information about the product 160, the individual 115 making the purchase or acquisition, and the time of the transaction are saved and are accessible.

FIG. 8 illustrates a product-number-over-time-period limiting process 800. The version of FIG. 8 is similar to the version of FIG. 3. However, with the version of FIG. 3, the individual's acquisition history is over a time period that is the entire duration of an event, whereas with the version of FIG. 8, the time period (T) under consideration is a selectable time period preceding the attempted acquisition of regulated substance product 160, and the preceding time period and is entered into the processor 125 prior to, or during, the event. Examples of preceding time periods (T) that can be entered are 1 hour, 2 hours, 3 hours, 4 hours, etc. or even one day or one week. With this version, the processor 125 checks 805 to see if an individual 115 has purchased or otherwise acquired a regulated substance product 160 within the past time period (T). If the current purchase or acquisition request is the first purchase or acquisition by the individual 115 of the regulated substance product 160 or is the only purchase or acquisition request within the preceding time period (T), the processor routine continues to step 810 where a counter associated with the individual 115 is set to 1, and the transaction is authorized 220. If the transaction is not the first such transaction for the individual 115 within the preceding time period (T), the processor 125 proceeds to step 815 where the individual's counter is increased by 1. The processor 125 then subtracts from the counter any purchases or acquisitions that were before the time period (T) to have a current counter value. Alternatively, rather than the addition and subtraction steps, the processor 125 may simply add all purchases or acquisitions that have occurred by the individual during the preceding time period (T) in determining the current counter value. The current value of the counter is then compared 820 to the imposed limit on purchases or acquisitions of the product 160 during the preceding time period (T) that has been preset and pre-entered into the processor 125. If the individual's current counter is greater than the preset limit, the transaction is denied 225. Otherwise, the transaction is approved 220. Once authorized, the individual can continue with the purchase or acquisition of the product 160 in conventional manner. Following the transaction, the individual's counter is saved 325, as with the version of FIG. 3, so that it can be referred to again when the individual attempts another purchase or acquisition of the product 160. If the individual decides to not proceed with the purchase or acquisition following authorization, the counter will revert back to its setting prior to the current transaction authorization request.

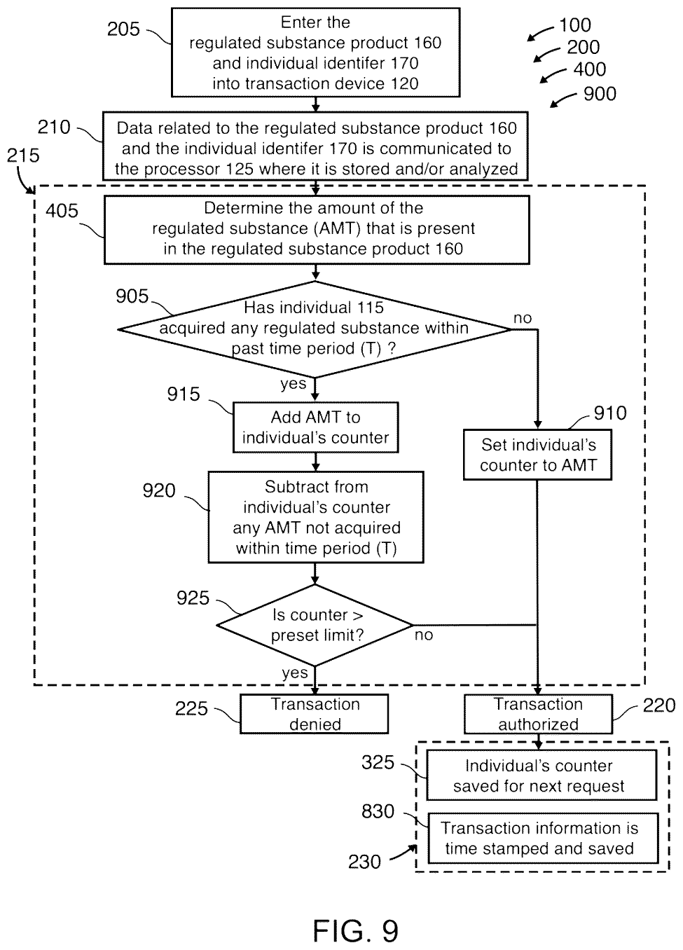

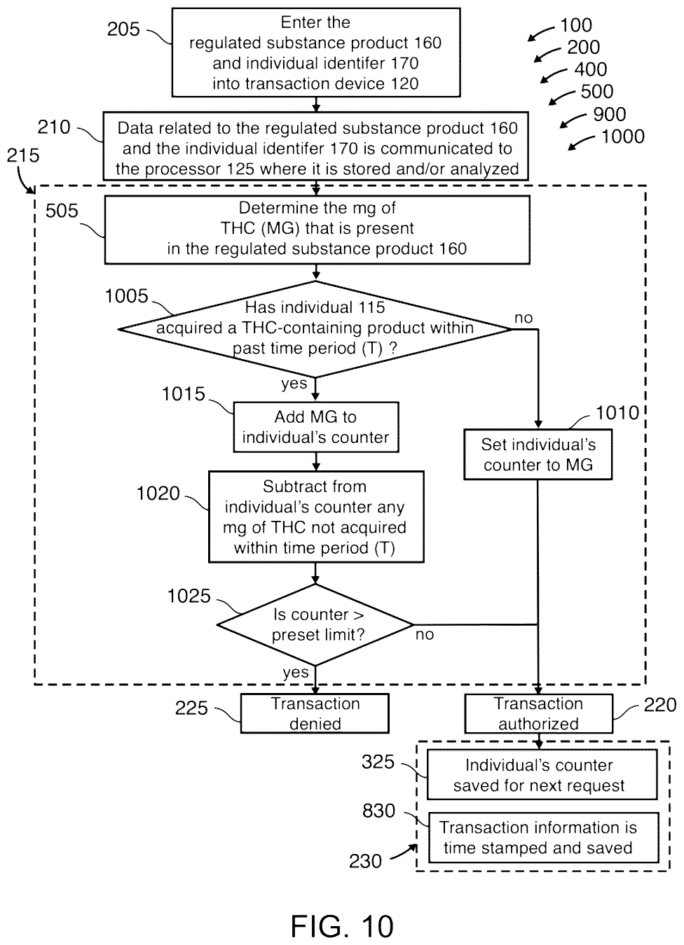

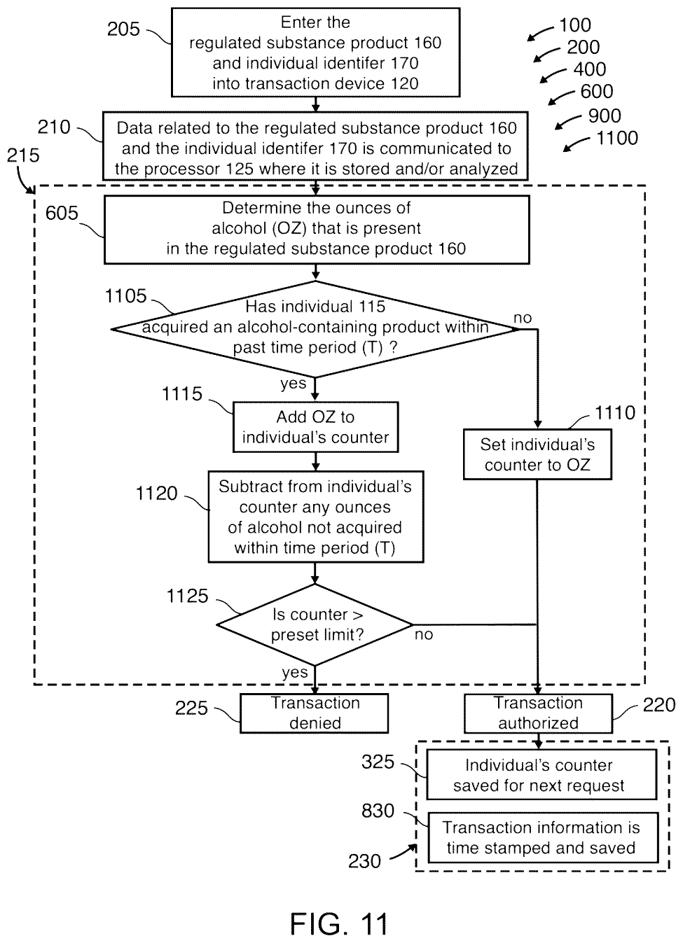

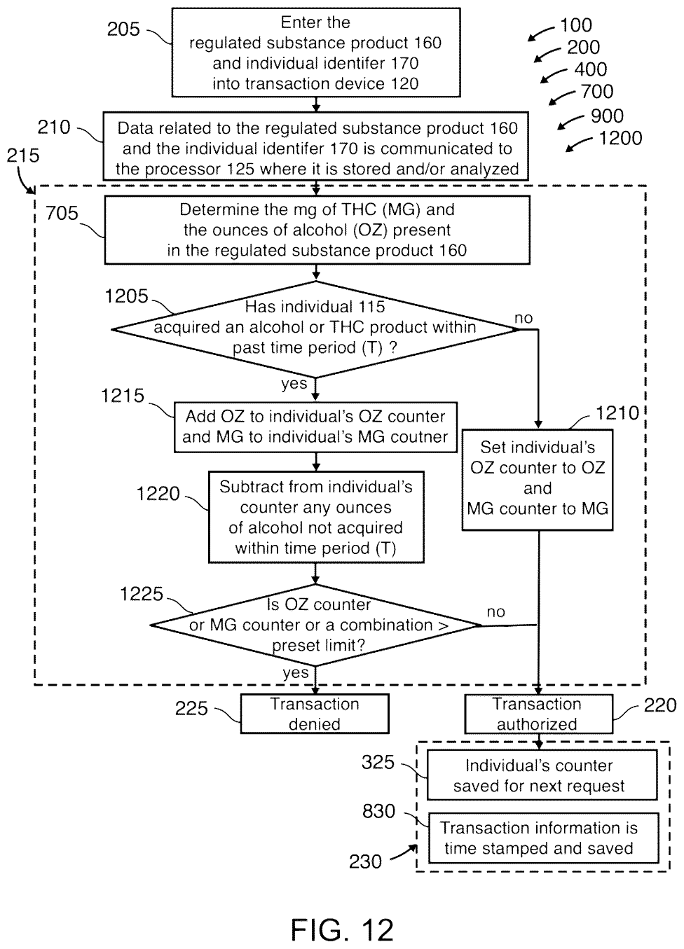

FIG. 9 illustrates a regulated-substance-amount-over-time-period limiting process 900. The version of FIG. 9 is similar to the regulated substance amount limiting process 400 of FIG. 4, but with the preceding time period (T) being taken into account. Accordingly, steps 905, 910, 915, 920, and 925 are similar to steps 410, 415, 420, and 425 except that the evaluations are made over the time period (T) rather than for the entirety of the event. Similarly, FIGS. 10, 11, and 12 are specific version of a regulated-substance-amount-over-time-period limiting process 900 that are similar to the versions of FIGS. 5, 6, and 7, respectively, but with the time period (T) taken into account. More specifically, a THC amount over time limiting process 1000 of FIG. 10 is similar to the THC amount limiting process 500 of FIG. 5, and steps 1005, 1010, 1015, 1020, and 1025 are similar to steps 510, 515, 520, and 525 but with the time period (T) being the only period evaluation. In similar manner, an alcohol amount over time limiting process 1100 of FIG. 11 is similar to the alcohol amount limiting process 600 of FIG. 6, and steps 1105, 1110, 1115, 1120, and 1125 are similar to steps 610, 615, 620, and 625 but with the time period (T) being the only period evaluation. Also, a combination amount over time limiting process 1200 of FIG. 12 is similar to the combination amount limiting process 700 of FIG. 7, and steps 1205, 1210, 1215, 1220, and 1225 are similar to steps 710, 715, 720, and 725 but with the time period (T) being the only period evaluation.

With any of the above-mentioned processes, one or more various additional features and/or alterations can be provided. For example, the point of transaction system 100 can also include modules that are available in conventional point of sale systems, such as tax calculation and inventory tracking modules. The point of transaction system 100 can include sales transaction features, such as credit or debit card readers and/or banking transfer abilities or other payment systems. The point of transaction system 100 can also be equipped to perform age determinations to qualify an individual 115 for purchasing an age-regulated product or can be configured to skip that step in cases where an age check is performed before an individual is given an individual identifier 170 by an event. Optionally, the limits imposed by the point of transaction system 100 can be adjustable by weight of the individual 115 or other factor and/or can be adjusted by a sliding scale related to the amount of time that has passed since previous purchases.

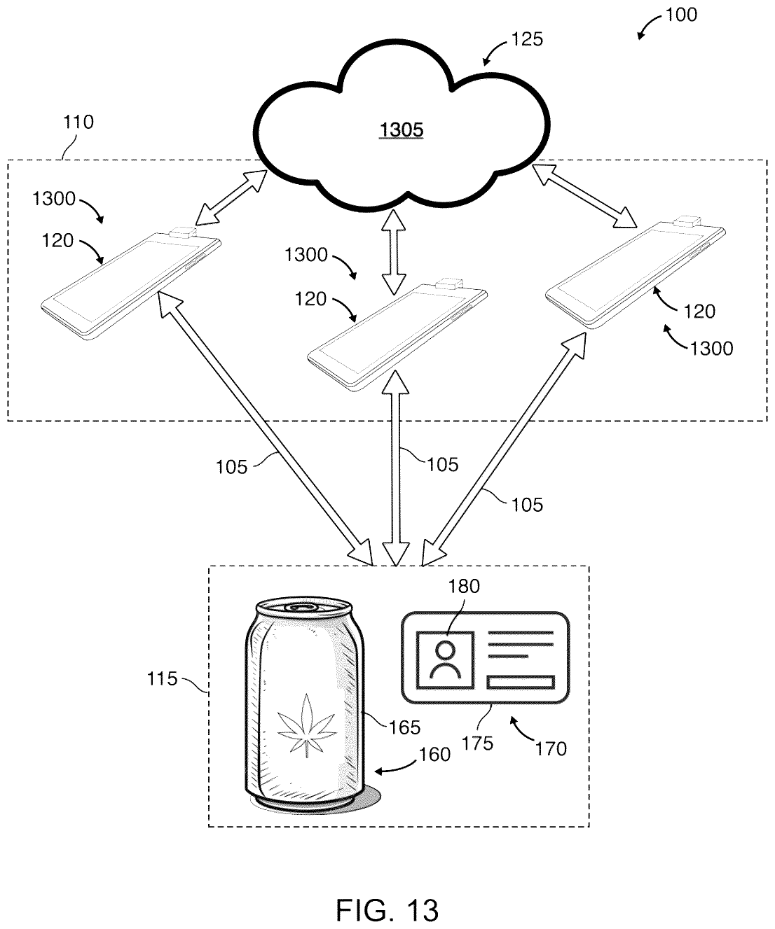

FIG. 13 illustrates a point of transaction system 100 in which the event that is selling or otherwise providing the regulated substance includes multiple transactional sites 1300, each transactional site 1300 being equipped with a transaction device 120. Each transactional site 1300 and/or transaction device 120 communicates with a common computer server 1305. The processor 125 can be contained within the computer server 1305 or is in communication therewith so that transactions at each of the transactional sites 1300 can be monitored and/or approved. Accordingly, when an individual 115 attempts to purchase or otherwise acquire a product at one transactional site 1300, the computer server 1305 and/or processor 125 will have a record of the individual's transactions at all of the transactional sites 1300. The multiple transactional sites 1300 can simply be different devices or kiosks within a single establishment or can be different stores or sellers that are all selling at an event. In another version, the different sites 1300 can be different bars or restaurants within a region, and they are able to communicate with one another through the computer server 1305 to monitor an individual's purchases or acquisitions within the region.

The transaction device 120 may be any device, network, or system that can communicate with the provider 110 and/or the individual 115 in accordance with one or more features of the present invention, and the computer server 1305 may be in the form of one or more servers and/or a cloud network made up of one or more servers. The provider 110 may be a person or any program that allows the provider 110 or individual 115 to interact with information on the computer server 1305, such as a traditional web browser available on most computers and hand-held devices. In one version, the transaction device 120 houses an internet browser and/or app that displays information on the transaction device 120 the display screen 150, such as a screen on a computer, television, or hand-held device. The transaction device 120 can interact with the computer server 1305. One way of interacting is through a touch 140 where various options are present to the user, and the user navigates through the transaction by touching one or more of the options and/or otherwise entering information.

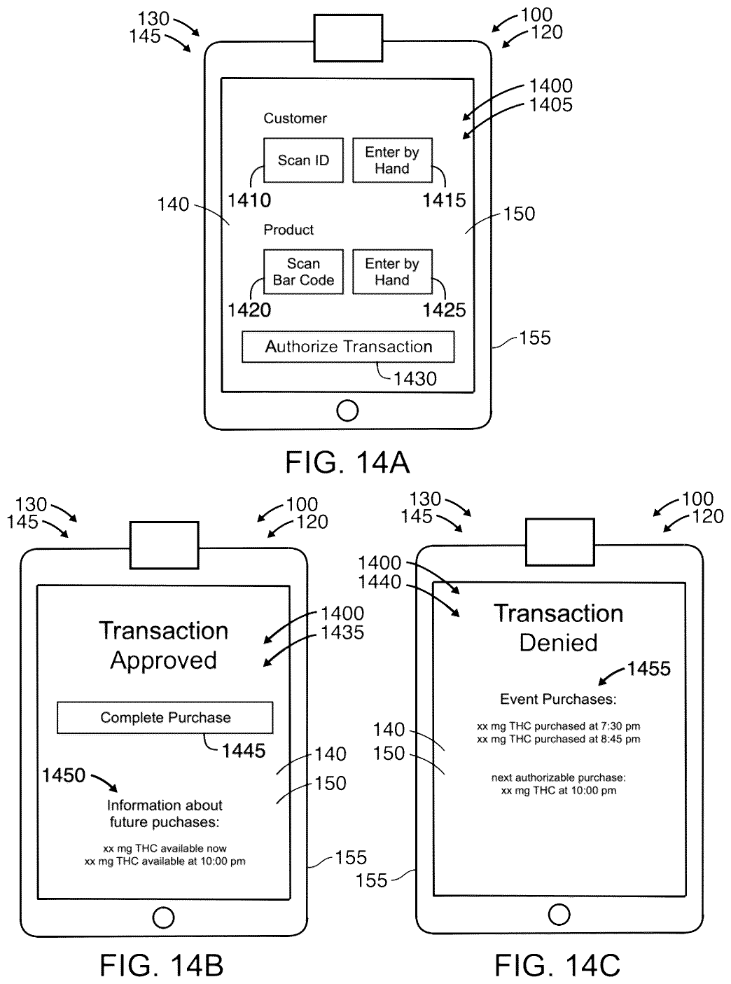

FIG. 14A shows a sample of a displayed image 1400 on a sample touch screen 140 or the like on a version of a transaction device 120 of the point of transaction system 100. In the version of FIG. 14A, the displayed image 1400 is a transaction authorization image 1405. The transaction authorization image 1405 can be present to the provider 110 when an individual 115 desires to purchase or otherwise acquire a regulated substance product 160. First, the individual 115 is identified via the individual identifier 170, as discussed above. For example, the provider 110 may select a Scan ID button 1410 which will enable a scanner to read the individual identifier 170, or the user may select a Enter by Hand button 1415 which will allow the provider 110 to otherwise enter identifying information for the individual 115, such as by entering the individual's driver's license number or other identifier. The regulated substance product 160 is then entered in similar manner, either by selecting a Scan Bar Code button 1420 or an Enter by Hand button 1425. Once the individual 115 and the product 160 are identified successfully, the provider 110 can select an Authorize Purchase button 1430, or the like, to allow the processor 125 and/or server 1305 to perform an assessment 215 as discussed above. Once the individual 115 and the product 160 are identified successfully, the provider 110 can select an Authorize Transaction button 1430, or the like, to allow the processor 125 and/or server 1305 to perform an assessment 215 as discussed above. The processor 125 and/or computer server 1305 will then return a Transaction Approved or Sale Approved image 1435, an example of which is shown in FIG. 14B, or a Transaction Denied or Sale Denied image 1440, an example of which is shown in FIG. 14C. The Transaction Approved image 1435 may include a Complete Purchase button 1445 through which the sales transaction or other acquisition process can be completed in conventional manner. Optionally, the Transaction Approved image 1435 can include additional information 1450 such as information about future purchases or acquisitions that can be made by the individual 115. Similarly, the Transaction Denied image 1440 can include information 1455 about data that resulted in the denial and/or about when a future purchase or acquisitions can be made.

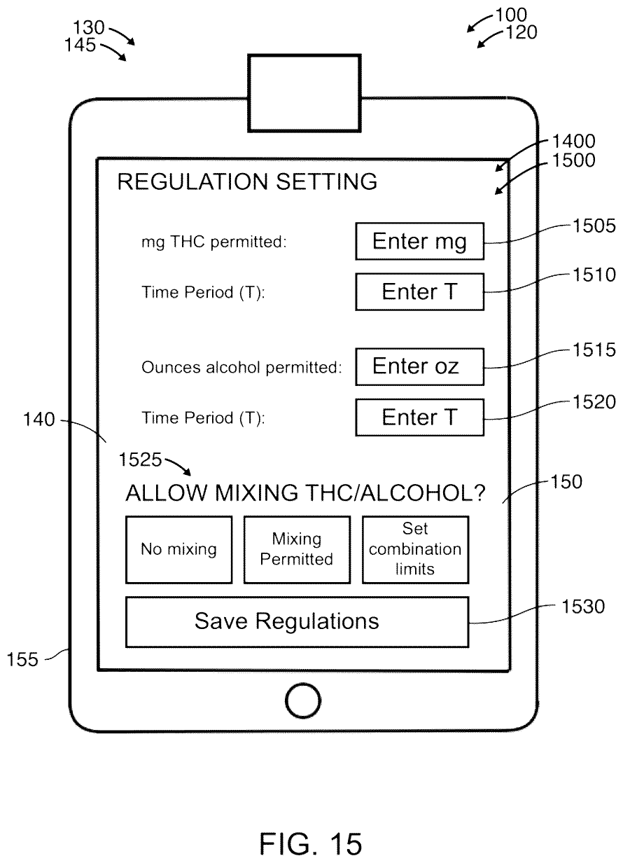

FIG. 15 shows a sample regulation entry screen 1500 that can be used by an event manager prior to an event to enter regulatory parameters into the point of transaction system 100 so that the point of transaction system 100 can monitor and/or make assessments concerning purchases or acquisitions during the event. In the version shown, the regulatory entry screen 1500 can be shown on and interacted with a transaction device 120. Typically, the screen and data entry will be password protected or the like so that only an authorized party can make adjustments. Alternatively, the regulatory adjustments may be required to be made on a separate device or may be locked in permanently. In the version of FIG. 15, the person using the regulation entry screen 1500 may, for example, enter the limits that are to be used by the processor 125 and/or computer server 1305 when making purchase or acquisition assessments 215. In the particular version shown, the person entering the information can select a THC mg button 1505 and/or a THC Time period button 1510. Additionally or alternatively, the person can enter alcohol information using an Alcohol Ounces button 1515 and/or an Alcohol Time period button 1520. Additional regulatory information 1525 can also be provided, such as whether and to what degree mixing of THC and alcohol will be permitted. Once everything is entered, the information can be saved in the processor 125 and/or computer server 1305 by hitting the save button 1530.

While the invention has been described as being or being a part of a point of transaction system, the invention can be embodied in a system that is separate from the sale or acquisition. In such a system, the transaction device would be a device that does not finalize the sale and/or the processor would be separated from the sales transaction. In addition or alternatively, while the invention has been described as being useful for transactions involving regulated substances and regulated substance products, the point of transaction system 100 can be used for selling or providing any product, particularly any product where there is to be a limit as to the number and/or amount sold or provided, and even more particularly any product where there is to be a limit as to the number and/or amount sold or provided over a time period.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and to include zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A point of transaction system for use by a provider of a regulated substance, the system comprising:
a transaction device comprising an input mechanism and an output mechanism, the input mechanism being adapted to receive (i) product information about a regulated substance product and (ii) acquirer information about an individual attempting to acquire the regulated substance product, the acquirer information comprising information related to the identification of the individual;
a processor within or in communication with the transaction device; and
a storage module within or in communication with the processor,
wherein the processor is adapted to:
receive the product information and the acquirer information from the transaction device;
determine an acquisition history of the individual;
assess whether the individual satisfies predetermined regulations at the time of an attempted acquisition based on the product information and the acquisition history of the individual;
generate an output signal in relation to the determination; and
provide the output signal to the transaction device,
wherein the provider can input the product information and the acquirer information into the transaction device using the input mechanism, and wherein the provider can receive from the transaction device output mechanism a transaction authorization when the individual satisfies the predetermined regulations or a transaction denial when the individual does not satisfy the predetermined regulations.

2. A point of transaction system according to claim 1 wherein the processor determines the acquisition history of the individual by determining a number of regulated substance products the individual has acquired within a preceding time period, wherein the processor assesses whether the individual satisfies the predetermined regulations by comparing the number of regulated substances the individual has acquired within the preceding time period to a preset limit, and wherein the processor generates the output signal by generating a transaction authorization output signal when the number of regulated substance products the individual has acquired within the preceding time period is below the preset limit and generating a transaction denial output signal when the number of regulated substance products the individual has acquired within the preceding time period is not below the preset limit.

3. A point of transaction system according to claim 2 wherein the storage module stores a record of each regulated substance products the individual has acquired and the time each regulated substance product was acquired by the individual, wherein the record is associated with the information related to the identification of the individual, and wherein the processor accesses the record using the information related to the identification of the individual and counts the number of regulated substance products the individual has acquired within the preceding time period to determine the number of regulated substance products the individual has acquired within the preceding time period.

4. A point of transaction system according to claim 2 wherein one or more of the preceding time period and the preset limit can be adjusted.

5. A point of transaction system according to claim 1 wherein the product information comprises the amount of regulated substance within the regulated substance product, wherein the processor determines the acquisition history of the individual by determining the amount of regulated substance the individual has acquired within a preceding time period, wherein the processor assesses whether the individual satisfies the predetermined regulations by comparing the amount of regulated substance the individual has acquired within the preceding time period to a preset limit, and wherein the processor generates the output signal by generating a transaction authorization output signal when the amount of regulated substance the individual has acquired within the preceding time period is below the preset limit and generating a transaction denial output signal when the amount of regulated substance the individual has acquired within the preceding time period is not below the preset limit.

6. A point of transaction system according to claim 5 wherein the storage module stores a record of each regulated substance products the individual has acquired, the amount of regulated substance in each of the regulated substance products the individual has acquired, and the time each regulated substance product was acquired by the individual, wherein the record is associated with the information related to the identification of the individual, and wherein the processor accesses the record using the information related to the identification of the individual and sums the amount of regulated substance the individual has acquired within the preceding time period to determine the amount of regulated substance the individual has acquired within the preceding time period.

7. A point of transaction system according to claim 5 wherein the product information comprises one or more of the amount of THC within the regulated substance product and the amount of alcohol within the regulated substance product.

8. A point of transaction system according to claim 5 wherein one or more of the preceding time period and the preset limit can be adjusted.

9. A point of transaction system according to claim 1 wherein the point of transaction system is a point of sale system, wherein the point of sale system is adapted to process a sales transaction of the regulated substance product, and wherein the output signal authorizes the sales transaction when the individual satisfies the predetermined regulations or denies the sale when the individual does not satisfy the predetermined regulations.

10. A point of transaction system according to claim 1 wherein the transaction device comprises a portable electronic device, wherein the input mechanism comprises a touchscreen or keyboard of the portable electronic device, and wherein the output mechanism comprises a display screen of the portable electronic device.

11. A point of transaction system according to claim 10 wherein the processor is housed within the portable electronic device or communicates with the portable electronic device remotely.

12. A point of transaction system according to claim 1 wherein the point of transaction system comprises a plurality of transaction devices, wherein the acquisition history of the individual includes acquisitions made from any of the plurality of transaction devices.

13. A point of transaction system according to claim 1 wherein the output mechanism is a display screen, wherein the transaction authorization is a visual display on the display screen indicating authorization, and wherein the transaction denial is a different visual display on the display screen indicating denial.

14. A point of transaction system according to claim 1 wherein when the individual is attempting to acquire a plurality of regulated substance products, the product information includes product information about each of the plurality of regulated substance products, and the processor assesses whether the individual satisfies the predetermined regulations based the product information for all of the plurality of regulated substance products and the acquisition history of the individual.

15. A method of determining whether a regulated substance product can be provided to an individual attempting to acquire the regulated substance product, the method comprising:
providing a transaction device comprising an input mechanism and an output mechanism;
using the input mechanism to enter product information about the regulated substance product;
using the input mechanism to enter acquirer information about individual, the acquirer information comprising information related to the identification of the individual;
determining an acquisition history of the individual;
assessing whether the individual satisfies predetermined regulations at the time of an attempted acquisition based on the product information and the acquisition history of the individual; and
using the output mechanism to indicate the individual is authorized to acquire the regulated substance product when the individual satisfies the predetermined regulations or to indicate the individual is denied from acquiring the regulated substance product when the individual does not satisfy the predetermined regulations.

16. A method according to claim 15 wherein the step of determining an acquisition history of the individual comprises determining a number of regulated substance products the individual has acquired within a preceding time period, and wherein the step of assessing whether the individual satisfies the predetermined regulations comprises comparing the number of regulated substances the individual has acquired within the preceding time period to a preset limit.

17. A method according to claim 15 wherein the product information comprises the amount of regulated substance within the regulated substance product, wherein the step of determining the acquisition history of the individual comprises determining the amount of regulated substance the individual has acquired within a preceding time period, and wherein the step of assessing whether the individual satisfies the predetermined regulations comprises comparing the amount of regulated substance the individual has acquired within the preceding time period to a preset limit.

18. A method according to claim 15 wherein the transaction device is a point of sale device, wherein the point of sale device is adapted to process a sales transaction of the regulated substance product, and wherein a sale is authorized when the individual satisfies the predetermined regulations and is denied when the individual does not satisfy the predetermined regulations.

19. A method according to claim 15 wherein the predetermined regulations are adjustable and wherein the method comprises adjusting the predetermined regulations.

20. A method of hosting an event in which a regulated substance is provided, the method comprising:
prior to providing a regulated substance to an individual in attendance at the event, determining the number of regulated substance products or the amount of the regulated substance the individual has been provided within a preceding time period,
if the number of regulated substance products the individual has been provided within the preceding time period is below a preset limit or if the amount of the regulated substance the individual has been provided within the preceding time period is below a preset limit, providing the individual with the regulated substance, and
if the number of regulated substance products the individual has been provided within the preceding time period is not below a preset limit or if the amount of the regulated substance the individual has been provided within the preceding time period is not below a preset limit, denying the individual the regulated substance.
